(19) United States
(12) Patent Application Publication
(10) Pub. No.: US 2008/0094739 A1
(43) Pub. Date: Apr. 24, 2008

(54) Vehicle mirror and components therefor

(76) Inventor: Catherine Louise Constable, Muswellbrook (AU)

Correspondence Address: KING & SCHICKLI, PLLC, 247 NORTH BROADWAY, LEXINGTON, KY, 40507, US

(21) Appl. No.: 11/585,438

(22) Filed: Oct. 24, 2006

(51) Int. Cl. G02B 7/182

(52) U.S. Cl. 359/876; 359/872

(57) ABSTRACT

An adjustable mirror apparatus suitable for operatively connecting to a mining truck or other prime mover to facilitate sight of extremities of the truck or prime mover from a cab is described. The adjustable mirror apparatus comprises, in a broad form, a reflecting assembly including a reflecting surface for displaying a reflected image of the one or more extremities of the truck, the reflecting assembly including an adjustment means for rotating the reflecting assembly about roll, and/or pitch and/or yaw axes relative to the truck or prime mover; and a manually releasable locking means operatively connected to the reflection assembly for controlling the rotation of the reflecting assembly. A replaceable mirror element is also described, as well as a mirror having a replaceable mirror element, and an adjusting mechanism.

### FIELD OF THE INVENTION

The present invention relates generally to vehicle mirrors, in particular for use as rear- and side-view mirrors on large trucks of the type commonly used in open pit mines. One aspect of the present invention relates particularly to replacement components for the vehicle mirrors, and another aspect of the invention relates to the vehicle mirror itself.

### BACKGROUND TO THE INVENTION

Trucks, especially those of the type used in open pit mines are huge and cumbersome affairs, and are difficult to manoeuver. It is critical to the maneuverability of the truck to reliably maintain clear vision of all the extremities of the truck from the controller's seat. It is also important to a mine's efficient functioning to reduce down time of the trucks so that delivery of material from the mine is kept high. One important contributor to truck down time is mirror adjustment during driver changes to accommodate different-sized drivers, and other mirror maintenance actions such as replacement and repair due to accidents, wear and tear and the like.

Known mirrors on large trucks are difficult to adjust. The adjustment requires specialist tools and skilled labour. Even then, the adjustment takes time and the requisite tools and labour are often difficult to find at the time that they are required. Some vehicles have electrical mechanisms for changing the position of the mirrors. Where a vehicle is used in harsh or dangerous conditions, for example, in mining applications, electrical systems may be a source of unnecessary maintenance or sparking. Further, motor operated mirror systems may be subject to abusive conditions in a mining environment that render them unsuitable. In demanding applications such as mines, it is also an advantage to take into account that even in normal use external mirrors are likely to be damaged and require repairs.

There is no provision for replacement parts for mirrors so that when part of the mirror is broken or damaged, the entire mirror must be replaced, which is expensive, time consuming and wasteful.

The present invention seeks to ameliorate one or more of the abovementioned disadvantages.

### SUMMARY OF THE INVENTION

According to one aspect of the present invention there is provided an adjustable mirror apparatus suitable for operatively connecting to a mining truck or other prime mover to facilitate sight of extremities of the truck or prime mover from a cab, the adjustable mirror apparatus including: a reflecting assembly including a reflecting surface for displaying a reflected image of the one or more extremities of the truck, the reflecting assembly including an adjustment means for rotating the reflecting assembly about roll, and/or pitch and/or yaw axes relative to the truck or prime mover; and a manually releasable locking means operatively connected to the reflection assembly for controlling the rotation of the reflecting assembly.

The manually releasable locking means may take any suitable form, such as for example, a sprung ratchet and pawl with manual handle or push-button clutch release, or a plurality of holes for receiving a sprung pin at discrete intervals along an arc. However, in preferred embodiments, the locking means is in the form of a clamp which, in one form, clamps a pivot plate to a mounting means so as to inhibit relative movement therebetween.

The clamp may be in any suitable form, but in one preferred embodiment it comprises a handle in the form of a T-Bar and a stem to elevate the handle clear of the reflecting assembly. Disposed at a base of the stem is a jaw so as to press down on an upper surface of the pivot plate to clamp the plate to the mounting means during clamping. The jaw is preferably, in a non-limiting embodiment in the form of a bulb or thickening of the stem, and in one form, may be a nut welded to the stem.

The stem comprises an advancing means to advance the jaw down onto the pivot plate. The advancing means could be in the form of an indexing means such as for example those used in hand-held bar clamps, but in preferred embodiments is a threaded base which engages with a lock nut disposed on or in the mounting means.

Preferably, in a non-limiting embodiment, the adjustment means comprises a cam and follower. Preferably, in a non-limiting embodiment, the cam is mounted on the pivot plate and comprises an arcuate aperture or track formed therein or thereon. Preferably, in a non-limiting embodiment, the follower is the locking stem of the manually releasable lock which passes through the track.

Preferably, in a non-limiting embodiment the mounting means comprises one or more mounting blocks for mounting to the truck or prime mover, and in one preferred embodiment, two spaced-apart mounting blocks for mounting the adjustment means.

Preferably, in a non-limiting embodiment the or each mounting block comprises a bore for receiving a pivot axle about which the reflecting assembly rotates.

The reflecting assembly may include a reflecting element which may be in the form of silver- or mercury-backed glass, or preferably, in a non-limiting embodiment, a polished stainless steel plate, and which may also include mounting suspension means in the form of padding for reducing rattles, disposed along the edges of the reflecting element.

Preferably, in a non-limiting embodiment, the reflecting element is manually replaceable.

Preferably, in a non-limiting embodiment, the reflecting assembly comprises a backing frame which comprises a recess for receiving the reflecting element. The reflecting assembly may further include a retention frame which is preferably, in a non-limiting embodiment in the form of a pivoting frame for retaining the reflecting element.

A frame locking means may be provided, which may be in any suitable form, for locking the retention frame to the backing frame. The frame locking means may be sprung balls which seat in frame recesses or behind small divot-shaped catches, but in preferred forms the frame locking means is in the form of one or more sprung pins which extend into catch apertures to lock the frames together. Preferably, in a non-limiting embodiment, handles on the sprung pins are provided, in the form of extensions extending normal to the elongate pin.

According to another aspect of the present invention there is provided a mirror apparatus suitable for operatively connecting to a mining truck or other prime mover to facilitate sight of extremities of the truck or prime mover from a cab, the mirror apparatus including: a reflecting assembly which comprises a manually replaceable reflecting element, replaceable while the mirror apparatus is operatively mounted to the mining truck.

The reflecting element may include a reflecting element which may be in the form of silver- or mercury-backed glass, or preferably, in a non-limiting embodiment, a polished stainless steel plate, and which may also include mounting suspension means in the form of padding for reducing rattles, disposed along the edges of the reflecting element.

Preferably, in a non-limiting embodiment, the reflecting assembly comprises a backing frame which comprises a recess for receiving the reflecting element. The reflecting assembly may further include a retention frame which is preferably, in a nonlimiting embodiment in the form of a pivoting frame for retaining the reflecting element.

A frame locking means may be provided, which may be in any suitable form, for locking the retention frame to the backing frame. The frame locking means may be sprung balls which seat in frame recesses or behind small divot-shaped catches, but in preferred forms the frame locking means is in the form of one or more spring pins which extend into catch apertures to lock the frames together. Preferably, in a non-limiting embodiment, handles on the sprung pins are provided, in the form of extensions extending normal to the elongate pin.

Preferably, in a non-limiting embodiment the reflecting assembly is adjustable and manually releasable as described above.

According to yet another aspect of the present invention there is provided a replacement reflecting means for a mirror which is suitable for use on trucks and prime movers, the replacement element including a mirror element which is adapted to be placed in a mounting recess and retained in the mounting recess by a retaining frame.

Preferably, in a non-limiting embodiment, gripping means are provided for facilitating removal of the mirror from the mounting recess. The gripping means may take any suitable form for facilitating removal of the mirror from the mounting recess, which may include ropes, and string looped around a base of the mirror element, or grip tape, or hooks. However, in one preferred form the gripping means is a catch which is in the form of a tab extending normal to the mirror element and disposed at an upper edge of the mirror element.

Preferably, in a non-limiting embodiment the mirror element comprises suspension means for inhibiting rattles, the suspension means in the form of pads disposed adjacent the retaining frame. Preferably, in a non-limiting embodiment the pads are disposed at peripheral edges of the mirror element.

Preferably, in a non-limiting embodiment the mirror element is sized to fit a mirror apparatus which is approximately 350×1120 mm.

### DESCRIPTION OF THE PREFERRED EMBODIMENTS

In order to enable a clearer understanding, the various aspects of the invention will hereinafter be described with reference to drawings and description of preferred embodiments. In the drawings:

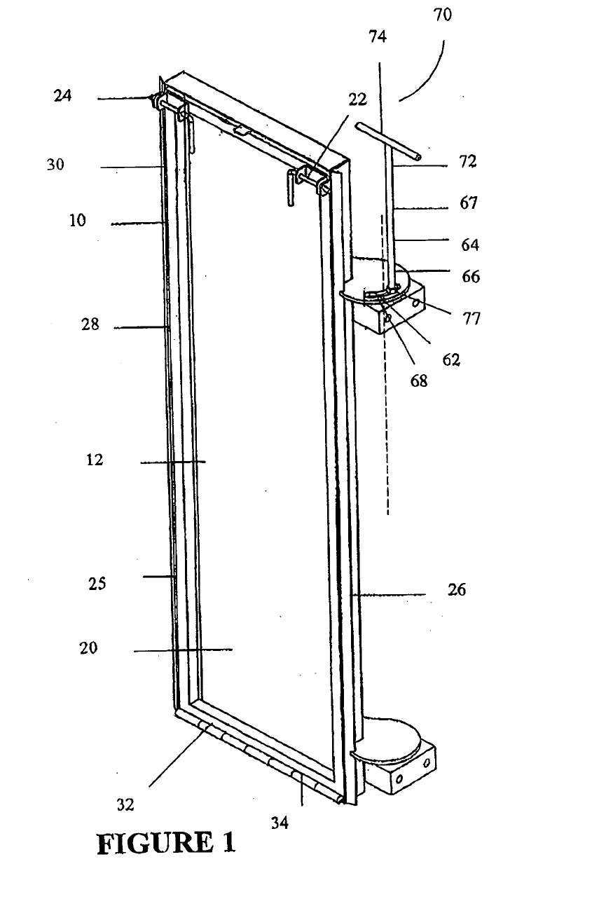

FIG. 1 is an isometric view of a mirror apparatus viewed from in front, above and a first side;

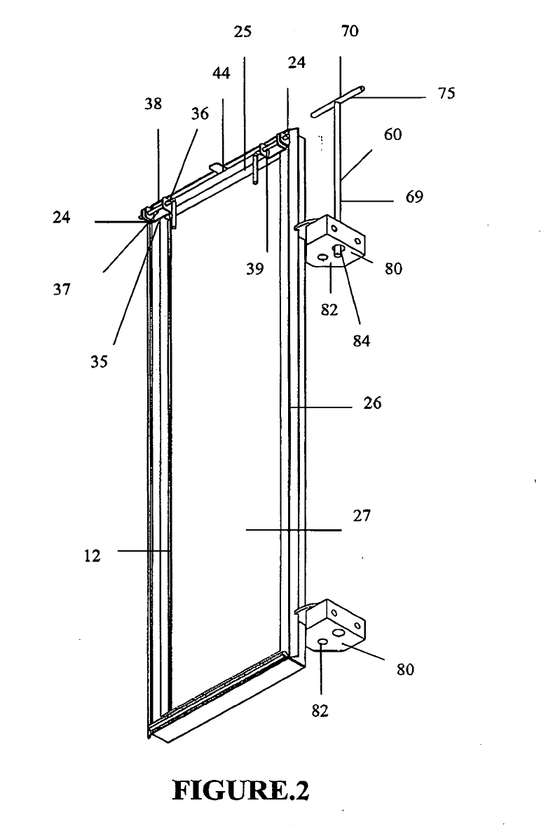

FIG. 2 is an isometric view of a mirror apparatus viewed from in front, above and from the other side from that shown in FIG. 1;

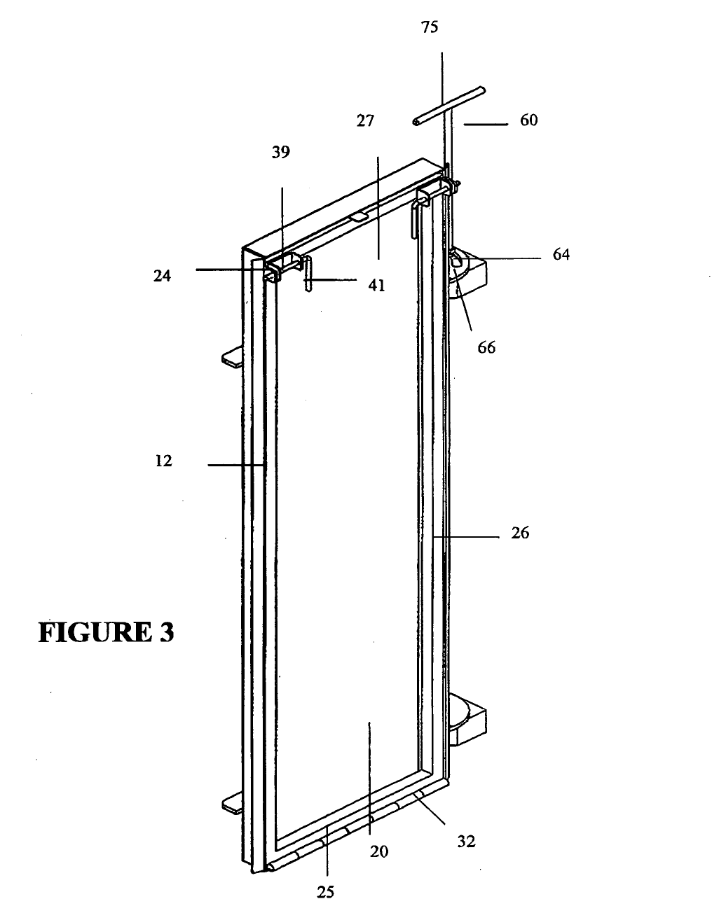

FIG. 3 is an isometric view of a mirror apparatus viewed from in front, below and from the first side;

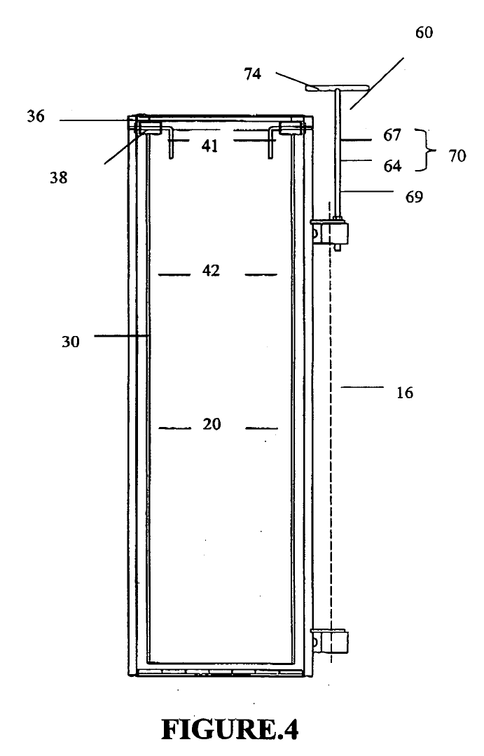

FIG. 4 is a front elevation view of the mirror apparatus;

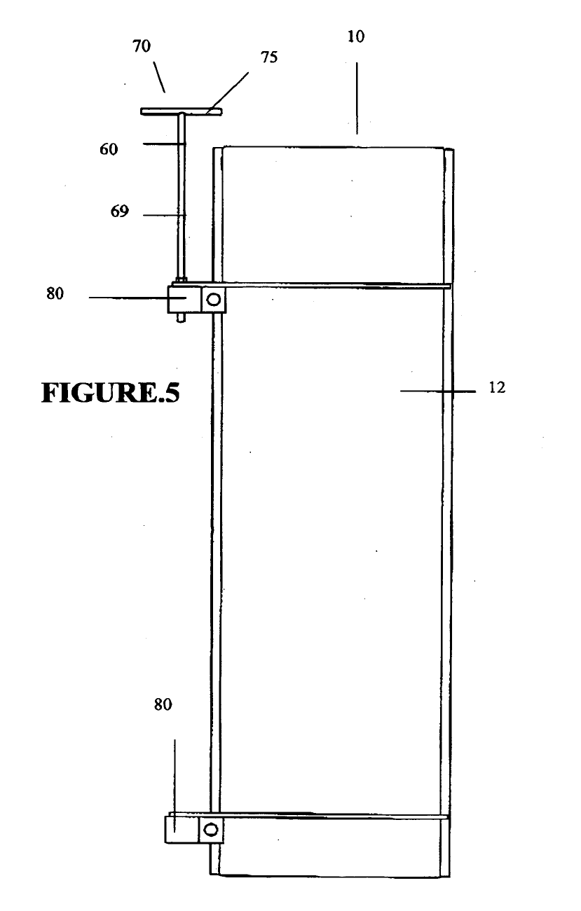

FIG. 5 is a rear elevation view of the mirror apparatus; and

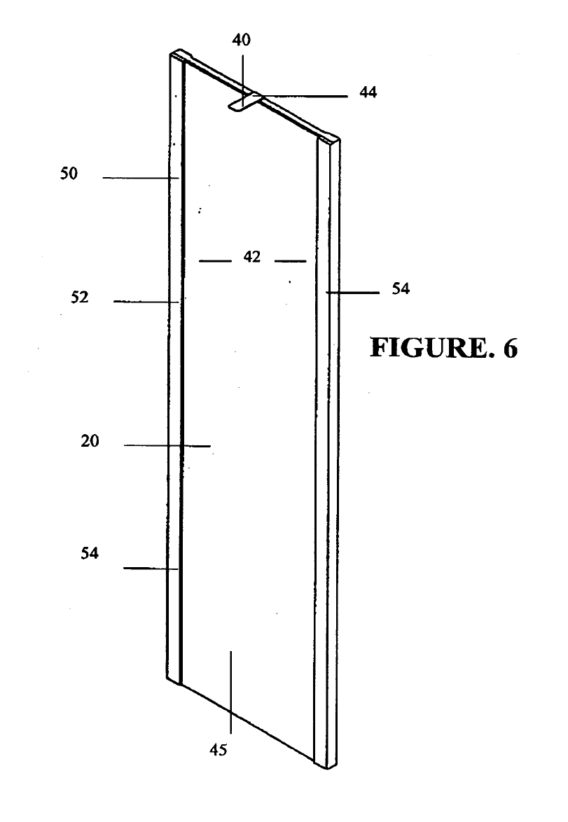

FIG. 6 is an isometric view of a replacement mirror element for use with the mirror apparatus.

Although there are several distinct aspects of the present invention separately defined herein, they will be described in the section hereinbelow and in other parts of this specification in combination with one another, but it is stressed that this is not to detract from the distinct nature of certain of the aspects of the present invention.

Referring to FIG. 1 there is shown a mirror apparatus generally indicated at 10. The apparatus 10 is shown to include a reflecting assembly 12 which may be manually adjusted inboard or outboard, without additional special tools, about a selected axis 14. which in the drawings shown is the yaw axis 16. Furthermore. the reflecting assembly 18 is shown to be operable to manually and quickly change out a mirror element 20 by sliding sprung clips 22 back from catches 24.

The reflecting assembly 12 includes a chassis 26 which includes a backing frame 28 which includes spaced apart, opposed lip walls 29 which form a recess 27 for receiving and mounting mirror element 20. The chassis 26 also includes a retaining frame 28 for retaining the mirror element 20 in the recess 27. The retaining frame 28 includes peripheral frame bars or tubes 25.

Access means 30 are provided to provide access to the mirror element 20. The access means 30 include a hinge 32 operatively connected to a peripheral tube 25 disposed at a base edge 34 of the retaining frame 28. The access means 30 also includes an access control means 36 in the form of a lock 38 in the form of a pair of elongate pins 39 which include biasing means 37 in the form of springs 35 which bias the pins 39 into catches 33. Handles 41 on the pins 39 extend perpendicularly to a longitudinal pin 39 axis to facilitate opening of locking means 38.

The mirror element 20 includes a flat reflecting plane 42 though it could be slightly convex-outwards, to extend the field of view. The mirror element 20 may be formed from a polished stainless steel sheet or plate 45 and includes a grip means 40 which includes a tab 44 which extends perpendicularly to the reflecting plane 42. The tab 44, when the mirror 20 is installed in the recess 27, extends past the retaining frame elements 25 to indicate to a user to grip in this region if the mirror needs removal for maintenance, replacement, and the like.

The mirror element 20 further includes suspension means 50 in the form of pads 52 mounted at peripheral edges 54 of the mirror element 20. This is to reduce rattles when mounted in the recess.

An adjustment means 60 is provided in order to adjust the reflecting assembly 12 about the yaw axis 16, though the same arrangements could easily be utilized to provide adjustment about the roll and pitch axes. The adjustment means 60 includes a cam 62 and follower 64, the cam 62 being mounted in a pivot plate 66 in the form of an arcuate aperture or track 68. The follower 64 is in the form of a stem 69 of a locking stem 67. Movement of the follower 64 in the cam 62 is limited by the ends or extent of the track 68. About 45° adjustment is provided by the arrangement shown.

A locking means 70 is provided which includes a clamp 72 in the form of a handle 74 which includes a T-bar 75 and the stem 69 to elevate the T-bar 75 above the upper extremity of the reflecting assembly 12 so that knuckle hazards are reduced. The clamp 72 includes the pivot plate 66 which is forced downwards onto mounting means 80 by bulb or 10 nut 77 on stem 69. Stem 69 comprises a threaded base (not shown) which provides advancement of the bulb or nut 77 onto the pivot plate 66 for clamping.

The mounting means 80 is in the form of a pair of vertically spaced-apart mounting blocks 82 which include bores 84 for pivoting pivots (not shown) about the yaw axis 16. Captive nuts are also provided in the mounting blocks 82 in order to engage with threaded stem base.

In operation, at the beginning of a shift, an operator of a truck (not shown) may reach out and unscrew T-bar hand 75 to unlock the mirror from a clamped position. The mirror may be pivoted about the yaw axis 16 and then the handle 74 is screwed back down until the nut 77 clamps down on pivot plate 66 and the reflecting assembly 12 is inhibited from further rotation. If the mirror 10 is bumped, there is no need to call for skilled trades people to adjust the mirror about the yaw or other axis.

If the mirror surface 20 is scarred, pitted, or otherwise wrecked, the pins 39 may be operated to gain access to the recess 27 and remove the mirror element 20.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

I claim:

1. An adjustable mirror apparatus suitable for operatively connecting to a mining truck or other prime mover to facilitate sight of extremities of the truck or prime mover from a cab. the adjustable mirror apparatus including: a reflecting assembly including a reflecting surface for displaying a reflected image of the one or more extremities of the truck. the reflecting assembly including an adjustment means for rotating the reflecting assembly about roll, and/or pitch and/or yaw axes relative to the truck or prime mover; and a manually releasable locking means operatively connected to the reflection assembly for controlling the rotation of the reflecting assembly.

2. An adjustable mirror in accordance with claim 1 wherein the manually releasable locking means is in the form of a clamp.

3. An adjustable mirror in accordance with claim 2 wherein the clamp clamps a pivot plate to a mounting means so as to inhibit relative movement therebetween.

4. An adjustable mirror in accordance with claim 2 wherein the clamp comprises a handle in the form of a T-Bar and a stem to elevate the handle clear of the reflecting assembly to reduce knuckle graze hazards.

5. An adjustable mirror in accordance with claim 4 wherein the stem comprises a jaw in the form of a bulb so as to press down on an upper surface of the pivot plate to clamp the plate to the mounting means during clamping.

6. An adjustable mirror in accordance with claim 4 wherein the stem comprises an advancing means to advance the jaw down onto the pivot plate, the advancing means in the form a threaded base which is adapted to engage with a lock nut disposed on or in the mounting means.

7. An adjustable mirror in accordance with claim 1 wherein the adjustment means comprises a cam and follower.

8. An adjustable mirror in accordance with claim 7 wherein the Cam is mounted on the pivot plate and comprises an arcuate aperture or track formed therein or thereon.

9. An adjustable mirror in accordance with claim 8 wherein the follower is the locking stem of the manually releasable lock which passes through the track.

10. An adjustable mirror in accordance with claim 1 wherein the mounting means comprises one or two mounting blocks for mounting the adjustment means, wherein the or each mounting block comprises a bore for receiving a pivot axle about which the reflecting assembly rotates.

11. An adjustable mirror in accordance with claim 1 wherein the reflecting assembly comprises a manually replaceable mirror element.

12. An adjustable mirror in accordance with claim 1 wherein the reflecting assembly comprises an access means in the form of a pivoting retention frame for retaining the reflecting element, so as to facilitate access to the manually replaceable mirror element.

13. An adjustable mirror in accordance with claim 12 wherein an access means lock may be provided, which include one or more sprung pins which extend into catch apertures to lock the frames together, and handles on the sprung pins in the form of extensions extending normal to the elongate pin.

14. A mirror apparatus suitable for operatively connecting to a mining truck or other prime mover to facilitate sight of extremities of the truck or prime mover from a cab, the mirror apparatus including: a reflecting assembly which comprises a manually replaceable reflecting element, replaceable while the mirror apparatus is operatively mounted to the mining truck.

15. A mirror apparatus in accordance with claim 14 wherein the reflecting assembly comprises a reflecting element which comprises suspension means in the form of padding for reducing rattles, disposed along peripheral edges of the reflecting element.

16. A mirror apparatus in accordance with claim 14 wherein the reflecting assembly comprises an access means which comprises a retention frame which comprises a pivoting frame for retaining the reflecting element.

17. A mirror apparatus in accordance with claim 14 wherein access locking means include or more sprung elongate pins which extend into catch apertures to inhibit access to the mirror element, and wherein handles on the sprung pins are provided, in the form of extensions extending normal to the elongate pin.

18. A replacement reflecting element for a mirror which is suitable for use on trucks and prime movers, the replacement element including a mirror element which is adapted to be placed in a mounting recess and retained in a mounting recess by a retaining frame.

19. A replacement reflecting element for a mirror in accordance with claim 18 wherein gripping means are provided for facilitating removal of the mirror from the mounting recess.

20. A replacement reflecting element for a mirror in accordance with claim 18 wherein the gripping means comprises a catch which is in the form of a tab extending normal to the mirror element and disposed at an upper edge of the mirror element.

21. A replacement reflecting element for a mirror in accordance with claim 18 wherein the mirror element comprises a suspension for inhibiting rattles, the suspension including pads disposed adjacent the retaining frame, at peripheral edges of the mirror element.
